(19) United States
(12) Patent Application Publication
(10) Pub. No.: US 2026/0258834 A1
(43) Pub. Date: Sep. 3, 2026

(54) BEARING DEVICE AND MOTOR

(71) Applicant: MINEBEA MITSUMI Inc., Kitasaku-gun, Nagano (JP)

(72) Inventors: Kentaro SUZUKI, Kitasaku-gun, Nagano (JP); Kouji KEBUKAWA, Kitasaku-gun, Nagano (JP)

(21) Appl. No.: 19/163,986

(22) PCT Filed: Mar. 4, 2024
(86) PCT No.: PCT/JP2024/008008

§ 371 Date: Sep. 10, 2025

(30) Foreign Application Priority Data
Mar. 17, 2023 (JP) 2023-042630

(51) Int. Cl. F16C 19/08; F16C 35/063

(52) U.S. Cl. CPC F16C 19/08; F16C 35/063; F16C 2380/26

(57) ABSTRACT

A bearing device includes: a shaft including a first end part and a second end part; a sleeve having a projecting part projecting from an inner peripheral surface opposing an outer peripheral surface of the shaft; a first bearing at the first end part side including an inner ring, an outer ring, and a rolling element; and a second bearing at the second end part side including an inner ring, an outer ring, and a rolling element. In an axis (x) direction, the projecting part is disposed between the first bearing and the second bearing, the outer ring of one of the first bearing and the second bearing is in contact with the projecting part, and the outer ring of the other of the first bearing and the second bearing is disposed apart from the projecting part. In the axis (x) direction, the inner ring of the first bearing is disposed at the first end part side relative to the outer ring, and the inner ring of the second bearing is disposed at the second end part side relative to the outer ring.

### TECHNICAL FIELD

The present invention relates to a bearing device and a motor including the bearing device.

### BACKGROUND ART

For example, as disclosed in Patent Literature 1, there is a known blower including a shaft, a sleeve having a cylindrical shape around an axis of the shaft, a pair of bearings fixed at an inner peripheral surface of the sleeve to rotatably support the shaft, and a spring applying a preload to each of the bearings.

### CITATION LIST

### Patent Literature

Patent Literature 1: WO 2019/111430 A

### SUMMARY OF INVENTION

### Technical Problem

In such a blower, when the shaft rotates at high speed, the sleeve is thermally expanded by frictional heat in the bearing. When the sleeve extends along the axis due to thermal expansion, the preload applied to the bearing can fluctuate. For example, an excessive increase in the preload shortens the life of the bearing.

Therefore, an example of an object of the present invention is to provide a bearing device and a motor capable of suppressing life reduction of a bearing.

### Solution to Problem

A bearing device according to one aspect of the present invention includes: a shaft including a first end part and a second end part; a sleeve having a projecting part projecting from an inner peripheral surface opposing an outer peripheral surface of the shaft; a first bearing including an inner ring, an outer ring, and a rolling element supported between the outer peripheral surface of the shaft and the inner peripheral surface of the sleeve at the first end part side; and a second bearing including an inner ring, an outer ring, and a rolling element supported between the outer peripheral surface of the shaft and the inner peripheral surface of the sleeve at the second end part side, wherein the projecting part is disposed between the first bearing and the second bearing in an axial direction of the shaft, the outer ring of one of the first bearing and the second bearing is in contact with the projecting part, and the outer ring of the other of the first bearing and the second bearing is disposed apart from the projecting part in the axial direction, the inner ring of the first bearing is disposed at the first end part side relative to the outer ring of the first bearing in the axial direction, and the inner ring of the second bearing is disposed at the second end part side relative to the outer ring of the second bearing in the axial direction.

### BRIEF DESCRIPTION OF DRAWINGS

FIG. 1 is an end view schematically illustrating a structure of a bearing device 1 according to a first embodiment of the present invention.

FIG. 2 is an end view schematically illustrating a structure of a motor 100 according to one specific example.

FIG. 3 is an end view schematically illustrating a state of thermal expansion at the motor 100 according to one specific example.

FIG. 4 is an end view schematically illustrating a structure of a bearing device 1A according to one modification of the first embodiment of the present invention.

FIG. 5 is an end view schematically illustrating a state of thermal expansion at a motor 100A according to another specific example.

FIG. 6 is an end view schematically illustrating a structure of a bearing device 1B according to a second embodiment of the present invention.

FIG. 7 is an end view schematically illustrating a state of thermal expansion at a motor 100B according to another specific example.

FIG. 8 is an end view schematically illustrating a structure of a motor 100C according to another specific example including a bearing device 1C according to a third embodiment of the present invention.

FIG. 9 is an end view schematically illustrating a state of thermal expansion at a motor 100C according to another specific example.

FIG. 10 is an end view schematically illustrating a structure of a motor 100D according to another specific example.

FIG. 11 is an end view schematically illustrating a structure of a motor 100E according to another specific example.

### DESCRIPTION OF EMBODIMENTS

### First Embodiment

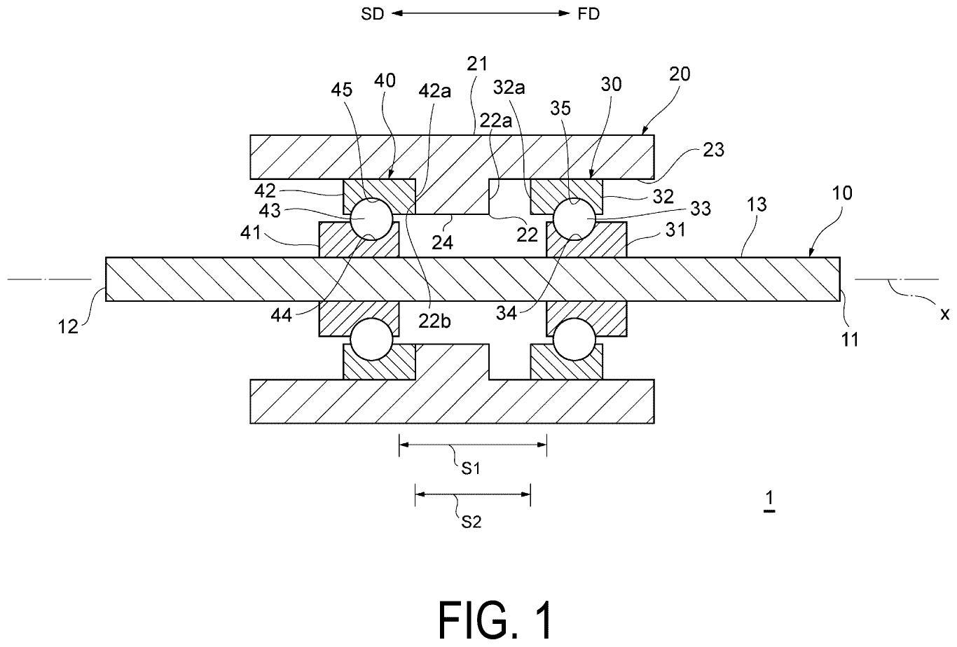

An embodiment of the present invention will be described below with reference to the accompanying drawings. FIG. 1 is an end view schematically illustrating the structure of a bearing device 1 according to the first embodiment of the present invention. This end view is an end view along a virtual plane including an axis x of a shaft 10 of the bearing device 1. The bearing device 1 includes the shaft 10, a sleeve 20, and a pair of a first bearing 30 and a second bearing 40. The shaft 10 is a rotation axis having a cylindrical shape, for example. At least a part of the shaft 10 is accommodated in the sleeve 20. The first bearing 30 and the second bearing 40 are supported between the shaft 10 and the sleeve 20.

The shaft 10 defines a first end part 11 and a second end part 12. The first end part 11 is one end part in the axis x direction and the second end part 12 is the other end part opposite to the first end part 11 in the axis x direction. Of the bearing device 1, a direction from the second end part 12 toward the first end part 11, in the axis x direction, is defined as a first direction FD, and a direction from the first end part 11 toward the second end part 12 is defined as a second direction SD. In a radial direction orthogonal to the axis x, a direction toward the axis x is defined as an inner peripheral side, and a direction away from the axis x is defined as an outer peripheral side.

An outer peripheral surface 13 is formed at the shaft 10 between the first end part 11 and the second end part 12. The outer peripheral surface 13 extends cylindrically with the axis x as a central axis. The shaft 10 is formed of a metal material, for example. The linear expansion coefficient of the shaft 10 is in a range of, for example, 10 to 13×10⁻⁶/° C. In the present embodiment, the shaft 10 has the same diameter between the first end part 11 and the second end part 12. However, the shaft 10 may have a partially different diameter between the first end part 11 and the second end part 12.

The sleeve 20 includes a cylinder part 21 as a tube part and a projecting part 22. The cylinder part 21 defines an inner peripheral surface 23 extending cylindrically with the axis x as a central axis. The inner peripheral surface 23 opposes the outer peripheral surface 13 of the shaft 10 in a radial direction. The projecting part 22 projects on the inner peripheral side in a radial direction from the inner peripheral surface 23 of the cylinder part 21 between both end parts of the cylinder part 21 in the axis x direction. The projecting part 22 is formed annularly over an entire circumference around the axis x. An inner peripheral surface 24 of the projecting part 22 opposes the outer peripheral surface 13 of the shaft 10. Note that the projecting part 22 may be formed of a plurality of parts apart from each other in a circumferential direction around the axis x. In the present embodiment, the both end parts of the cylinder part 21 in the axis x direction are open.

The cylinder part 21 and the projecting part 22 are integrally formed of a metal material, for example. In the present embodiment, the linear expansion coefficient of the sleeve 20 is different from the linear expansion coefficients of the shaft 10 and the first bearing 30 and the second bearing 40 described later. Specifically, the linear expansion coefficient of the sleeve 20 is in a range of, for example, 15 to 25×10⁻⁶/° C., preferably in a range of 16 to 20×10⁻⁶/° C., and more preferably at a range of 17 to 18×10⁻⁶/° C. That is, the linear expansion coefficient of the sleeve 20 is set to be larger than the linear expansion coefficients of the shaft 10, the first bearing 30, and the second bearing 40.

The pair of the first bearing 30 and the second bearing 40 are supported between the outer peripheral surface 13 of the shaft 10 and the inner peripheral surface 23 of the sleeve 20. In the axis x direction, the first bearing 30 is disposed at the first end part 11 side relative to the projecting part 22, and the second bearing 40 is disposed at the second end part 12 side relative to the projecting part 22. That is, the projecting part 22 is disposed between the first bearing 30 and the second bearing 40 in the axis x direction.

The first bearing 30 includes an inner ring 31, an outer ring 32 disposed at the outer peripheral side of the inner ring 31, and a plurality of rolling elements 33 disposed between the inner ring 31 and the outer ring 32. The inner ring 31 and the outer ring 32 are annular members with the axis x as a central axis. That is, the axis x is also an axis of the first bearing 30. An inner ring raceway 34 is formed at the outer peripheral surface of the inner ring 31, and an outer ring raceway 35 is formed at the inner peripheral surface of the outer ring 32. The plurality of rolling elements 33 are arrayed in the circumferential direction around the axis x between the inner ring raceway 34 and the outer ring raceway 35. The rolling element 33 is a sphere, and thus the first bearing 30 is a rolling ball bearing. Note that the plurality of rolling elements 33 are held by, for example, an annular retainer (not illustrated).

The inner ring 31 is supported by the outer peripheral surface 13 of the shaft 10 at the inner peripheral surface of the inner ring 31. The outer ring 32 is supported by the inner peripheral surface 23 of the sleeve 20 at the outer peripheral surface of the outer ring 32. In the present embodiment, the inner ring 31 is fixed at the shaft 10 by press-fitting. On the other hand, the outer ring 32 is clearance-fitted to the sleeve 20 and fixed at the sleeve 20 with an adhesive. As described later, preload is performed on the first bearing 30 due to the inner ring 31 being disposed and offset to the first end part 11 side, that is, in the first direction FD with respect to the outer ring 32 in the axis x direction. Note that in the drawings, the offset arrangement in the axis x direction of the inner ring 31 and the outer ring 32 is illustrated exaggeratedly.

On the other hand, similarly to the first bearing 30, the second bearing 40 includes an inner ring 41, an outer ring 42 disposed at the outer peripheral side of the inner ring 41, and a plurality of rolling elements 43 disposed between the inner ring 41 and the outer ring 42. The inner ring 41 and the outer ring 42 are annular members with the axis x as a central axis. That is, the axis x is also an axis of the second bearing 40. An inner ring raceway 44 is formed at the outer peripheral surface of the inner ring 41, and an outer ring raceway 45 is formed at the inner peripheral surface of the outer ring 42. The plurality of rolling elements 43 are arrayed in the circumferential direction around the axis x between the inner ring raceway 44 and the outer ring raceway 45. The rolling element 43 is a sphere, and thus the second bearing 40 is a rolling ball bearing. Note that the plurality of rolling elements 43 are held by, for example, an annular retainer (not illustrated).

The inner ring 41 is supported by the outer peripheral surface 13 of the shaft 10 at the inner peripheral surface of the inner ring 41. The outer ring 42 is supported by the inner peripheral surface 23 of the sleeve 20 at the outer peripheral surface of the outer ring 42. In the present embodiment, the inner ring 41 is fixed at the shaft 10 by press-fitting. On the other hand, the outer ring 42 is clearance-fitted to the sleeve 20 and fixed at the sleeve 20 with an adhesive. As described later, preload is performed on the second bearing 40 due to the inner ring 41 being disposed and offset to the second end part 12 side, that is, in the second direction SD with respect to the outer ring 42 in the axis x direction. Note that in the drawings, the offset arrangement in the axis x direction of the inner ring 41 and the outer ring 42 is illustrated exaggeratedly.

As obvious from FIG. 1, an end surface 32a facing the second direction SD of the outer ring 32 of the first bearing 30 is disposed apart from an end surface 22a of the projecting part 22 facing the first direction FD. On the other hand, an end surface 42a facing, in the axis x direction, the first direction FD of the outer ring 42 of the second bearing 40 is disposed in contact with an end surface 22b of the projecting part 22 facing the second direction SD. Due to the offset arrangement in the axis x direction of the inner rings 31 and 41 and the outer rings 32 and 42, a gap S1 between the inner ring 31 of the first bearing 30 and the inner ring 41 of the second bearing 40 in the axis x direction is larger than a gap S2 between the outer ring 32 of the first bearing 30 and the outer ring 42 of the second bearing 40.

The inner ring 31, the outer ring 32, and the rolling elements 33 of the first bearing 30, and the inner ring 41, the outer ring 42, and the rolling elements 43 of the second bearing 40 are made of a metal material. The linear expansion coefficients of the inner ring 31 and the outer ring 41 of the first bearing 30 and the inner ring 41 and the outer ring 42 of the second bearing 40 are in a range of, for example, 10 to 13×10⁻⁶/° C. That is, the linear expansion coefficients of the first bearing 30 and the second bearing 40 are different from the linear expansion coefficient of the sleeve 20. Specifically, the linear expansion coefficients of the inner ring 31 and the outer ring 32 of the first bearing 30 and the inner ring 41 and the outer ring 42 of the second bearing 40 are set to be smaller than the linear expansion coefficient of the sleeve 20.

Next, an assembly method of the bearing device 1 according to the present embodiment will be described below. First, the second bearing 40 is attached to the shaft 10 and the sleeve 20. Specifically, the inner ring 41 of the second bearing 40 is press-fitted from the second end part 12 side to a predetermined position of the shaft 10. On the other hand, the outer ring 42 of the second bearing 40 is fitted to the sleeve 20 by clearance-fitting. The end surface 42a of the outer ring 42 is in contact with the end surface 22b of the projecting part 22. In this state, the outer peripheral surface of the outer ring 42 is fixed at the inner peripheral surface 23 of the sleeve 20 with an adhesive.

Thereafter, the first bearing 30 is attached to the shaft 10 and the sleeve 20. Specifically, the inner ring 31 of the first bearing 30 is press-fitted from the first end part 11 side to a predetermined position of the shaft 10. The predetermined position is a position where a gap between the inner ring 31 and the inner ring 41 in the axis x direction is the gap S1 described above. At the same time, the outer ring 32 of the first bearing 30 is fitted to the sleeve 20 by clearance-fitting. The end surface 32a facing the second direction SD of the outer ring 32 is disposed apart from the end surface 22a of the projecting part 22 in the axis x direction.

At this time, with the sleeve 20 being fixed, a load is applied, in the second direction SD, to the outer ring 32 of the first bearing 30 by, for example, a preload spring (not illustrated). The outer ring 32 moves in the second direction SD. As a result, the outer ring 32 is disposed to be relatively offset with respect to the inner ring 31 in the second direction SD. Thus, the first bearing 30 is applied with a preload due to the offset arrangement between the inner ring 31 and the outer ring 32 in the axis x direction.

Since the inner ring 31 is press-fitted into the shaft 10, movement of the inner ring 31 in the second direction SD is also caused at the time of movement of the outer ring 32 in the second direction SD. As a result, the shaft 10 moves in the second direction SD. Since the inner ring 41 of the second bearing 40 is press-fitted into the shaft 10, the inner ring 41 is disposed and offset with respect to the outer ring 42 in the second direction SD by movement of the shaft 10 in the second direction SD. As a result, the second bearing 40 is applied with a preload.

At this time, a gap between the outer ring 32 of the first bearing 30 and the outer ring 42 of the second bearing 40 is set to the gap S2. The end surface 32a of the outer ring 32 of the first bearing 30 and the end surface 22a of the projecting part 22 are apart from each other. In this state, the outer peripheral surface of the outer ring 32 of the first bearing 30 is fixed at the inner peripheral surface 23 of the sleeve 20 with an adhesive. A preload spring is removed after fixing the outer ring 32 to the sleeve 20. Thus, the bearing device 1 is assembled.

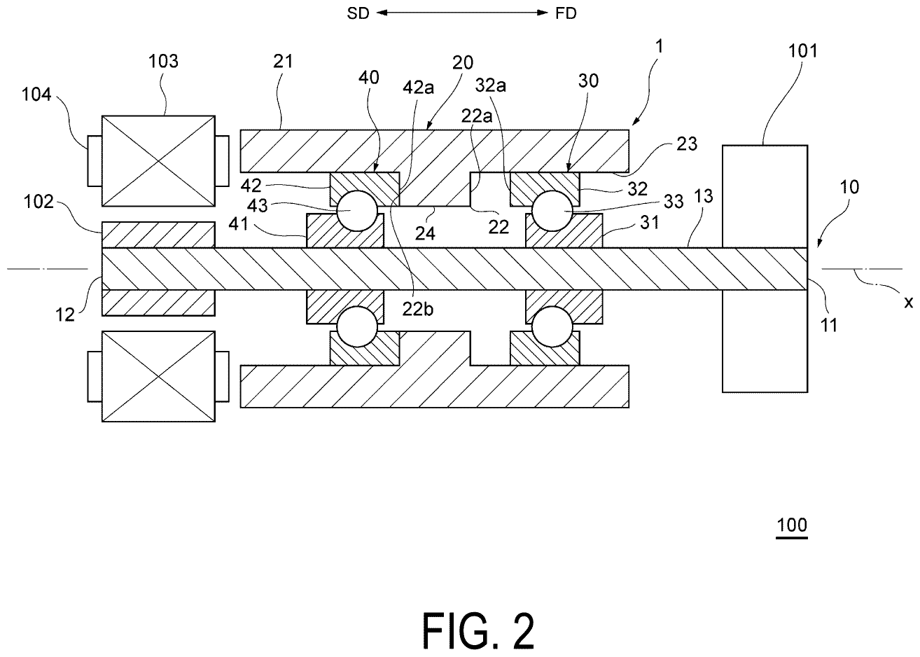

Next, an example of a usage aspect of the bearing device 1 according to the present embodiment will be described below. FIG. 2 is an end view schematically illustrating the structure of the motor 100 according to one specific example. The motor 100 according to this specific example includes the bearing device 1 described above, a member 101, a magnet 102, a stator core 103, and a coil 104. The motor 100 is a motor capable of rotating the member 101 at high speed about the axis x at, for example, 30000 rpm or more.

The member 101 is fixed at the shaft 10 at the first end part 11 side of the first bearing 30. In this example, the member 101 is fixed at the first end part 11. On the other hand, the magnet 102 is fixed at the shaft 10 at the second end part 12 side with respect to the second bearing 40. In this example, the magnet 102 is fixed at the second end part 12. The magnet 102 is, for example, a cylindrical permanent magnet. The magnet 102 constitutes a rotor of the motor 100. In this manner, at the shaft 10, the relatively large member 101 having weight x diameter is disposed at the first end part 11 side rather than the second end part 12 side, thus a load is applied to the rotor. For example, when the member 101 oscillates around the axis x, a component in a rotation direction and a component in a rotation axis direction are generated as a burden (load). Here, examples of the member 101 include a belt and a gear.

An inner peripheral surface of the stator core 103 having a cylindrical shape opposes an outer peripheral surface of the magnet 102. A plurality of the coils 104 are wound around each tooth of the stator core 103. The stator core 103 is formed of a stacked body of a magnetic material, for example. The stator core 103 and the coil 104 constitute a stator of the motor 100. As well known, the shaft 10, that is, the member 101 rotates about the axis x by a magnetic interaction between a magnetic field generated at the stator core 103 and a magnetic field of the magnet 102.

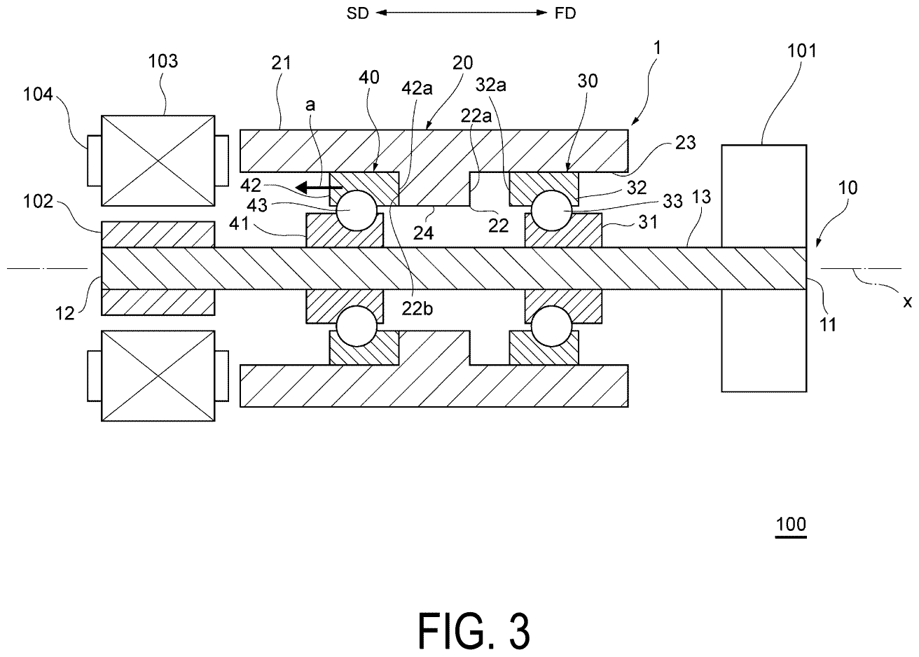

When the shaft 10, that is, the member 101 rotates at high speed of, for example, 30000 rpm or more, frictional heat is generated between the inner rings 31 and 41 and the outer rings 32 and 42 and the rolling elements 33 and 43 at the first bearing 30 and the second bearing 40. This frictional heat is conducted to the sleeve 20. As a result, the sleeve 20 thermally expands. FIG. 3 is an end view schematically illustrating the state of thermal expansion at the motor 100 according to one specific example. Here, attention is focused on thermal expansion of the sleeve 20 in the axis x direction in particular.

As illustrated in FIG. 3, when the sleeve 20 thermally expands in the axis x direction, the outer ring 42 of the second bearing 40 in contact with the end surface 22b of the projecting part 22 in the axis x direction moves toward the second direction SD due to the thermal expansion in the axis x direction of the projecting part 22 (arrow a). On the other hand, since the outer ring 32 of the first bearing 30 is not in contact with the end surface 22a of the projecting part 22 in the axis x direction, the outer ring 32 is not affected by the thermal expansion in the axis x direction of the projecting part 22. Since the outer rings 32 and 42 are fixed at the inner peripheral surface 23 of the cylinder part 21 with an adhesive, thermal expansion of the cylinder part 21 is absorbed by the adhesive.

As described above, at the second bearing 40, the outer ring 42 moves toward the second direction SD under the influence of the thermal expansion in the axis x direction of the projecting part 22. That is, the outer ring 42 moves in a direction of eliminating the offset arrangement of the inner ring 41 and the outer ring 42. As a result, the preload decreases at the second bearing 40. On the other hand, since the first bearing 30 is not affected by the thermal expansion of the projecting part 22, the positions of the inner ring 31 and the outer ring 32 are not changed. As a result, the preload is maintained at the first bearing 30.

According to the bearing device 1 and the motor 100 above, at the first bearing 30 and the second bearing 40, the gap S1 between the inner ring 31 and the inner ring 41 is set to be larger than the gap S2 between the outer ring 32 and the outer ring 42, and the outer ring 42 of the second bearing 40 is in contact with the projecting part 22 in the axis x direction. According to such a configuration, when the shaft 10 rotates at high speed, for example, the preload is maintained at the first bearing 30, while the preload decreases at the second bearing 40. It is possible to avoid an increase in preload at both the first bearing 30 and the second bearing 40. It is possible to suppress life reduction of the first bearing 30 and the second bearing 40.

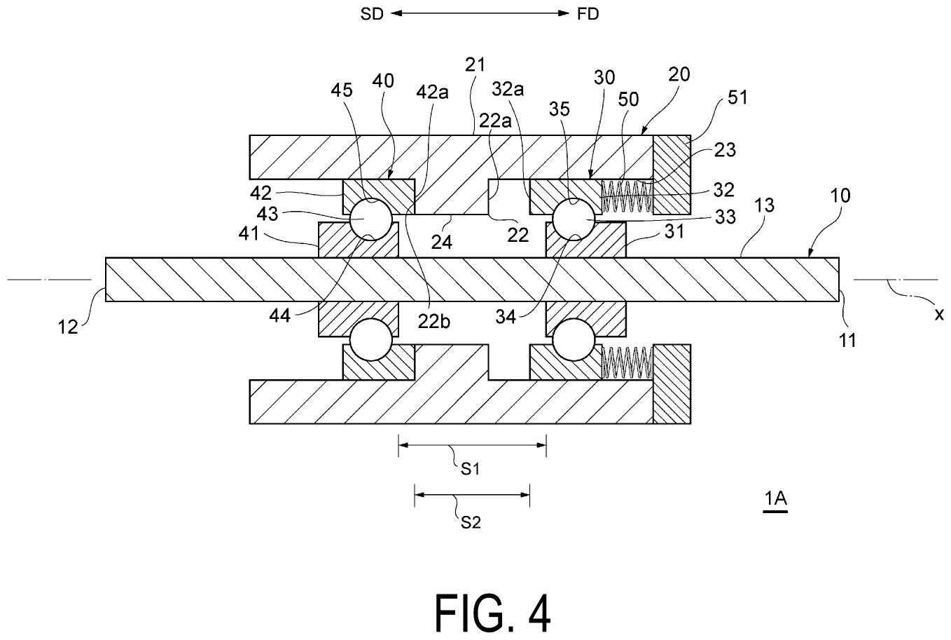

FIG. 4 is an end view schematically illustrating the structure of the bearing device 1A according to one modification. Hereinafter, differences in configuration from the bearing device 1 described above will be described. Note that similar components to components of the bearing device 1 described above are denoted by identical reference signs, and the description will be omitted. As illustrated in FIG. 4, this bearing device 1A has the outer ring 32 of the first bearing 30 clearance-fitted at the inner peripheral surface 23 of the sleeve 20. No adhesive is applied between the outer peripheral surface of the outer ring 32 and the inner peripheral surface 23 of the sleeve 20. That is, the outer ring 32 can move relatively in the axis x direction with respect to the sleeve 20.

The bearing device 1A includes an elastic member 50 and a holding member 51. The holding member 51 is attached to an end part at the first direction FD side of the cylinder part 21 of the sleeve 20. The holding member 51 is an annular member with the axis x as a central axis. The elastic member 50 is held at an inner surface of the holding member 51 facing the second direction SD. The elastic member 50 is an annular member with the axis x as a central axis. The elastic member 50 includes, for example, a coil spring or a leaf spring. The elastic member 50 is disposed between the outer ring 32 of the first bearing 30 and the holding member 51, and applies a load in the second direction SD to the outer ring 32.

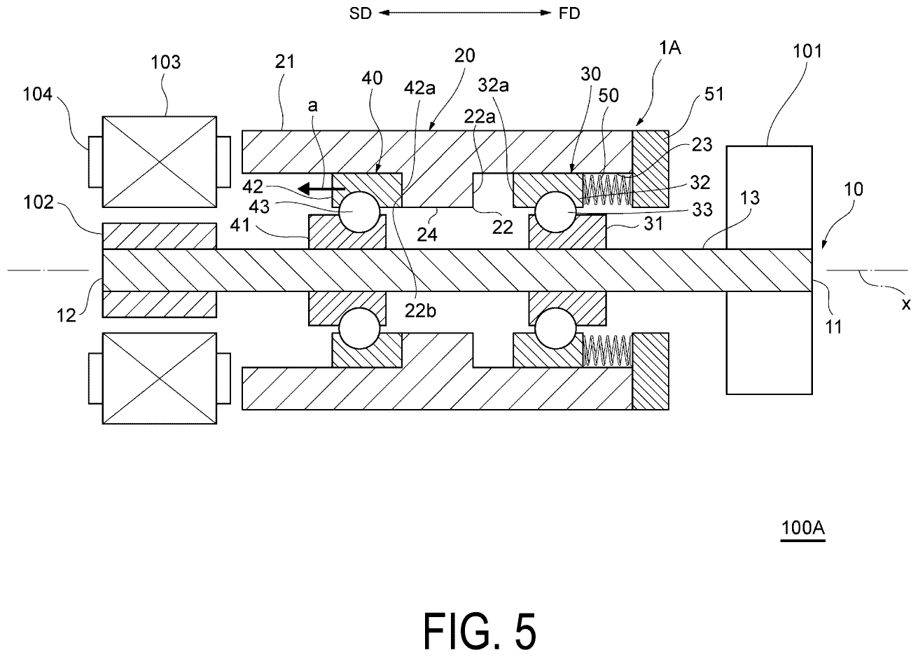

As illustrated in FIG. 5, the bearing device 1A is incorporated at the motor 100A. The configuration of the motor 100A is identical to the configuration of the motor 100 except the bearing device 1A being incorporated in place of the bearing device 1. When the shaft 10, that is, the member 101 rotates at high speed of, for example, 30000 rpm or more, the sleeve 20 thermally expands. The behavior of the second bearing 40 is similar to the behavior described above. On the other hand, at the first bearing 30, since the outer ring 32 is not fixed at the cylinder part 21, and the outer ring 32 is applied with a load from the elastic member 50, thermal expansion of the cylinder part 21 is absorbed by the elastic member 50.

In such a case, similarly to the case of the motor 100 described above, at the second bearing 40, the outer ring 42 moves in a direction of eliminating the offset between the inner ring 41 and the outer ring 42 under the influence of the thermal expansion of the projecting part 22, and thus the preload decreases at the second bearing 40. Since the first bearing 30 is not affected by the thermal expansion of the projecting part 22, the positions of the inner ring 31 and the outer ring 32 are not changed. As a result, the preload is maintained at the first bearing 30.

### Second Embodiment

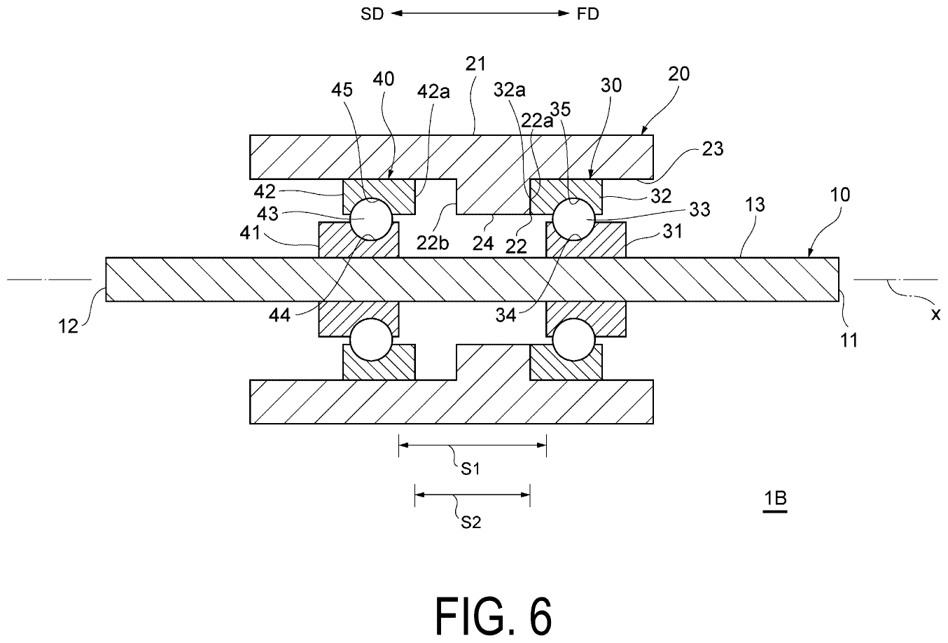

FIG. 6 is an end view schematically illustrating the structure of the bearing device 1B according to the second embodiment of the present invention. Hereinafter, differences in configuration from the bearing from the bearing device 1 described above will be described. Note that similar components to components of the bearing device 1 described above are denoted by identical reference signs, and the description will be omitted. This bearing device 1B has the end surface 22a of the projecting part 22 in contact with the end surface 32a of the outer ring 32 of the first bearing 30 in the axis x direction. On the other hand, the end surface 42a of the outer ring 42 of the second bearing 40 is disposed apart from the end surface 22b of the projecting part 22 in the axis x direction. Note that similarly to the bearing device 1, the inner rings 31 and 41 are press-fitted into the outer peripheral surface 13 of the shaft 10, while the outer rings 32 and 42 are clearance-fitted into the inner peripheral surface 23 of the sleeve 20 and fixed with an adhesive.

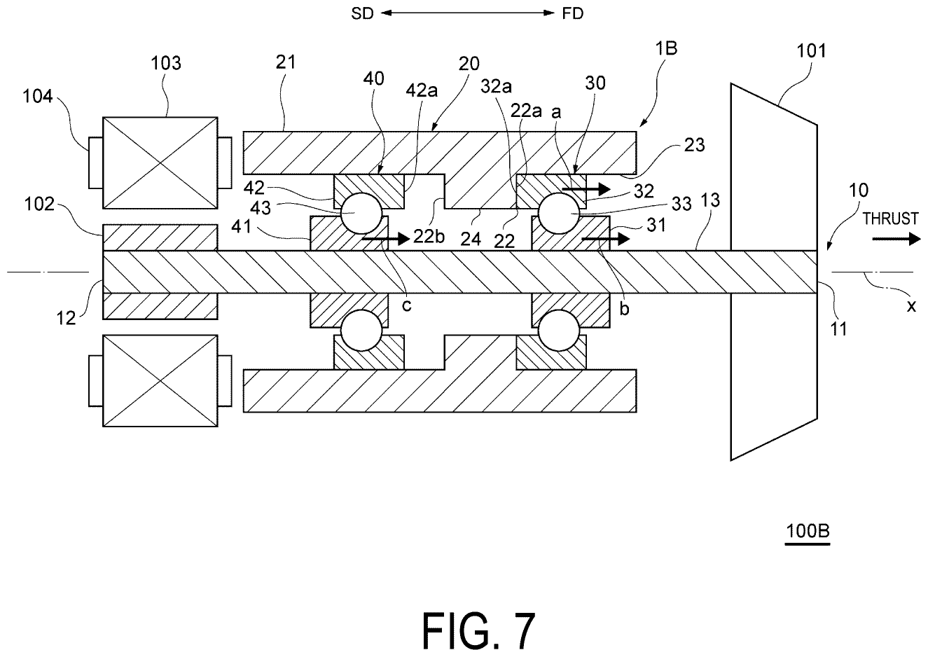

As illustrated in FIG. 7, the bearing device 1B is incorporated at the motor 100B. In this example, the member 101 is an impeller, that is, the motor 100B is a fan motor. When the shaft 10, that is, the member 101 rotates at high speed of, for example, 30000 rpm or more, the sleeve 20 thermally expands. The outer ring 32 of the first bearing 30 in contact with the projecting part 22 in the axis x direction moves toward the first direction FD due to the thermal expansion of the projecting part 22 (arrow a). On the other hand, the outer ring 42 of the second bearing 40 not in contact with the projecting part 22 in the axis x direction is not affected by the thermal expansion of the projecting part 22. Since the outer rings 32 and 42 are fixed at the inner peripheral surface 23 of the cylinder part 21 with an adhesive, thermal expansion of the cylinder part 21 is absorbed by the adhesive.

As illustrated in FIG. 7, at the motor 100B, thrust toward the first direction FD is generated by high-speed rotation of the member 101, that is, the impeller. When the thrust by the impeller exceeds a magnetic attractive force between the stator core 103 and the magnet 102, the shaft 10 is attracted in the first direction FD. In response to movement of the shaft 10 toward the first direction FD, the inner ring 31 of the first bearing 30 and the inner ring 41 of the second bearing 40 fixed at the shaft 10 move in the first direction FD (arrow b and arrow c).

In such a case, at the first bearing 30, since both the inner ring 31 and the outer ring 32 move toward the first direction FD, the preload is maintained at the first bearing 30. At the second bearing 40, since the inner ring 41 moves in the direction of eliminating the offset between the inner ring 41 and the outer ring 42, the preload decreases at the second bearing 40. Therefore, it is possible to avoid an increase in preload at the first bearing 30 and the second bearing 40. It is possible to suppress life reduction of the first bearing 30 and the second bearing 40.

### Third Embodiment

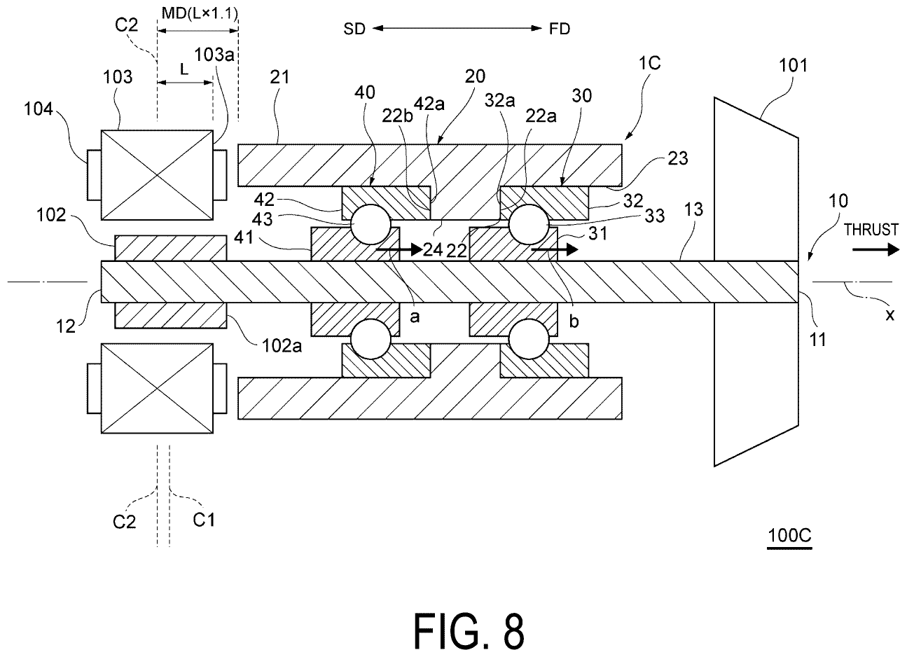

FIG. 8 is an end view schematically illustrating the structure of the motor 100C. The bearing device 1C according to the third embodiment of the present invention is incorporated in the motor 100C. Hereinafter, differences in configuration from the bearing device 1 will be described. Note that similar components to the components described above are denoted by identical reference signs, and the same description will be omitted. The bearing device 1C has the outer ring 32 of the first bearing 30 in contact with the end surface 22a of the projecting part 22 at the end surface 32a facing the second direction SD. The inner ring 31 is disposed and offset in the second direction SD with respect to the outer ring 32, and thus a preload is applied to the first bearing 30. Note that the inner ring 31 is supported by being press-fitted into the shaft 10, and the outer ring 32 is supported by being clearance-fitted at the inner peripheral surface 23 of the sleeve 20.

On the other hand, the outer ring 42 of the second bearing 40 is in contact with the end surface 22b of the projecting part 22 at the end surface 42a facing the first direction FD. the inner ring 41 is disposed and offset in the second direction SD with respect to the outer ring 42, and thus a preload is applied to the second bearing 40. Note that the inner ring 41 is supported by being press-fitted into the shaft 10, and the outer ring 42 is supported by being clearance-fitted at the inner peripheral surface 23 of the sleeve 20. In the present example, the amount of offset of the inner ring 31 with respect to the outer ring 32 at the first bearing 30 is set equal to the amount of offset of the inner ring 41 with respect to the outer ring 42 at the second bearing 40.

At the motor 100C, the position in the axis x direction of the magnet 102 fixed at the shaft 10 is adjusted. Specifically, when the shaft 10 is stationary, a center position C1 of the magnet 102 defined in the axis x direction is shifted to the first direction FD side with respect to a center position C2 of the stator core 103 similarly defined in the axis x direction. This shift amount is set such that, when the shaft 10 moves toward the first direction FD to the maximum at the time of high-speed rotation of the shaft 10, the position of an end surface 102a at the first direction FD side of the magnet 102 falls within a maximum distance MD. The maximum distance MD is 1.1 times a length L from the center position C2 of the stator core 103 to an end surface 103a at the first direction FD side of the stator core 103.

Next, the shaft 10, that is, the member 101 is assumed to rotate at high speed of, for example, 30000 rpm or more. Note that in this example, the member 101 is an impeller, that is, the motor 100C is a fan motor. When the thrust by the high-speed rotation of the member 101 exceeds the magnetic attractive force between the stator core 103 and the magnet 102, the shaft 10 is attracted in the first direction FD. In response to movement of the shaft 10 toward the first direction FD, the inner ring 41 of the second bearing 40 and the inner ring 31 of the first bearing 30 move in the first direction FD (arrow a and arrow b). By the inner ring 41 and the inner ring 31 moving with respect to the outer ring 42 and the outer ring 32, respectively, in this manner, the preload decreases at the second bearing 40 and the first bearing 30.

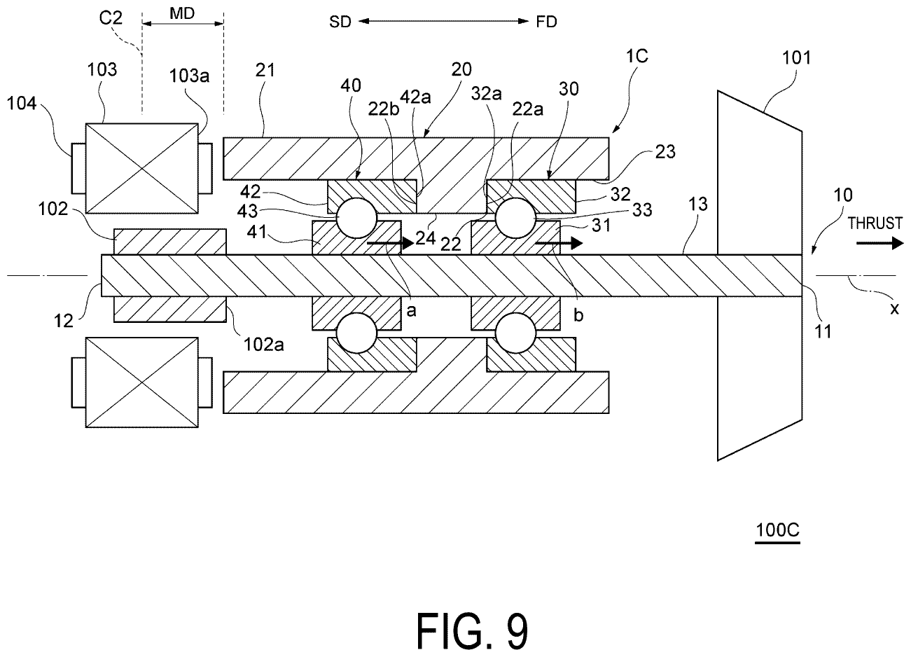

FIG. 9 is an end view schematically illustrating the structure of the motor 100C when the member 101 rotates at high speed with the maximum number of revolutions. As illustrated in FIG. 9, when the member 101 rotates at high speed with the maximum number of revolutions of, for example, 30000 rpm or more, the member 101, that is, the shaft 10 moves in the first direction FD against the magnetic attractive force between the stator core 103 and the magnet 102. At this time, the position of the end surface 102a at the first direction FD side of the magnet 102 falls within the maximum distance MD. The maximum distance MD is 1.1 times the length L from the center position C2 of the stator core 103 to the end surface 103a at the first direction FD side of the stator core 103. At this time, the preload remains decreasing at the first bearing 30 and the second bearing 40.

According to the bearing device 1C and the motor 100C as described above, the magnet 102 sufficiently opposes the stator core 103 in the axis x direction at the time of low-speed rotation of the member 101. Therefore, the thrust of the member 101 is below the magnetic attractive force between the stator core 103 and the magnet 102. As a result, the shaft 10 does not move toward the first direction FD. That is, since the magnet 102 can continue to sufficiently oppose the stator core 103, a torque constant is maximized.

On the other hand, when the thrust of the member 101 exceeds the magnetic attractive force between the stator core 103 and the magnet 102 at the time of high-speed rotation of the member 101, the shaft 10 moves toward the first direction FD. An opposing region of the magnet 102 with respect to the stator core 103 decreases. As a result, since the torque constant is reduced, high-speed rotation of the shaft 10 becomes easy. With no preload being generated at the first bearing 30 and the second bearing 40, the shaft 1 can rotate most stably. As a result, reduction in power consumption can be achieved.

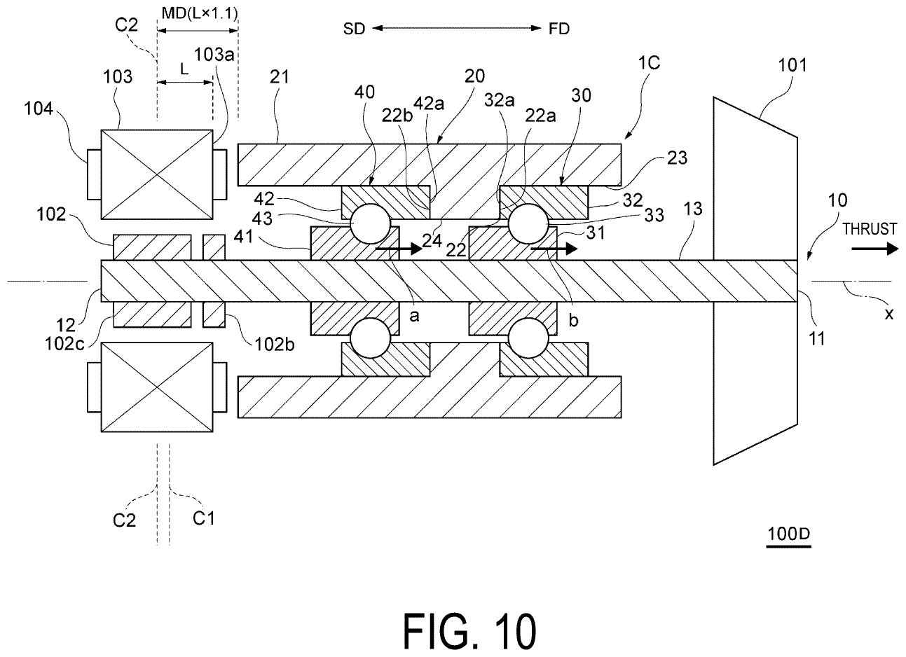

FIG. 10 is an end view schematically illustrating the structure of the motor 100D according to another specific example. As illustrated in FIG. 10, this motor 100D includes the bearing device 1C incorporated similarly to the motor 100C. The difference from the motor 100C is that the magnet 102 includes a first part 102b disposed at the first direction FD side and a second part 102c disposed at the second direction SD side relative to the first part 102b. In this example, the lengths of the first part 102b and the second part 102c defined in the axis x direction are set to be larger at the second part 102c than at the first part 102b.

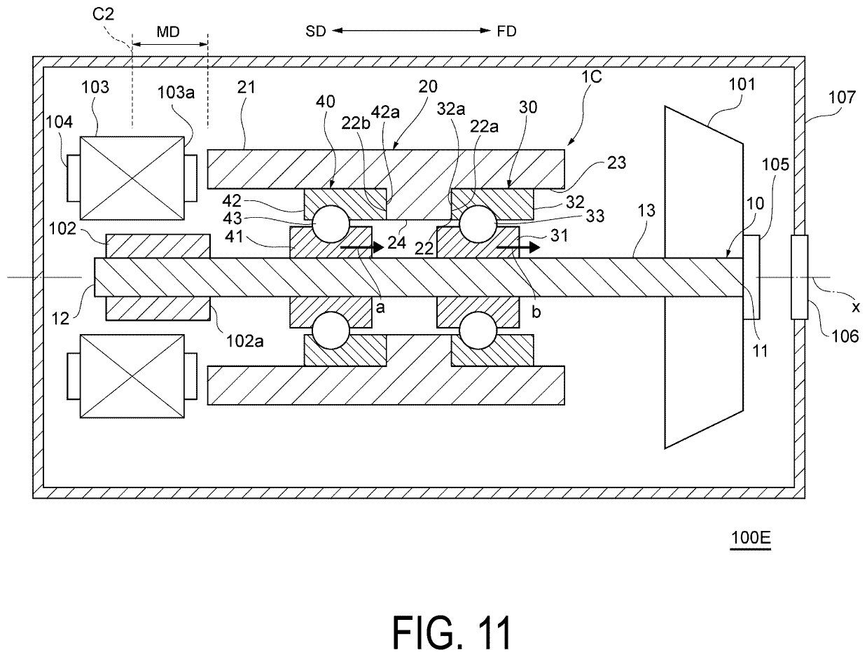

FIG. 11 is an end view schematically illustrating the structure of the motor 100E according to another specific example. As illustrated in FIG. 11, this motor 100E includes the bearing device 1C incorporated similarly to the motors 100C and 100D. The difference from the motor 100C is that the motor 100E includes a first magnet 105 attached to the member 101, that is, the impeller, a second magnet 106 opposing the first magnet 105 in the axis x direction, and a housing 107. The housing 107 accommodates a rotor and a stator of the motor 100E, for example. Note that FIG. 11 illustrates a state where the shaft 10 is moved in the first direction FD to the maximum at the time of high-speed rotation.

The second magnet 106 is fixed at the housing 107 of the motor 100E, for example. The first magnet 105 and the second magnet 106 opposing each other have identical magnetic poles opposing each other to generate repulsive forces repelling each other. Specifically, the repulsive force is set to be generated when the thrust of the member 101 exceeds the magnetic attractive force between the magnet 102 and the stator core 103 and as illustrated in FIG. 11, the shaft 10 moves in the first direction FD. Note that similar components to components described above are denoted by identical reference signs, and the same description will be omitted.

At the motor 100E as described above, since the repulsive force between the first magnet 105 and the second magnet 106 is generated when the shaft 10 moves in the first direction FD, further movement of the shaft 10 in the first direction FD is restricted. As a result, at the first bearing 30 and the second bearing 40, a preload in a direction opposite to the initial setting can be prevented from acting. Therefore, it is possible to reliably prevent breakage due to what is called shoulder riding at the first bearing 30 and the second bearing 40.

Although the present invention has been described through the above embodiments, the technical scope of the present invention is not limited to the scope described in the above embodiments. Various modifications or improvements can be made to the above embodiments, and this is obvious to a person having skill in the art. Such modified or improved form is also included in the technical scope of the present invention, and this is obvious from the description of the claims.

The above-described embodiments are intended to facilitate understanding of the present invention and are not intended to be construed as limiting. The components included in the above-described embodiments, arrangement, materials, conditions, shapes, sizes, or the like, of the components are not limited to those exemplified and may be appropriately changed. The components illustrated in the different embodiments can be replaced or combined partially to the extent not technically inconsistent.

### REFERENCE SIGNS LIST

1, 1A, 1B, 1C Bearing device, 10 Shaft, 11 First end part, 12 Second end part, 13 Outer peripheral surface, 20 Sleeve, 21 Cylinder part, 22 Projecting part, 23 Inner peripheral surface, 24 Inner peripheral surface, 30 First bearing, 31 Inner ring, 32 Outer ring, 32a End surface, 33 Rolling element, 34 Inner ring raceway, 35 Outer ring raceway, 40 Second bearing, 41 Inner ring, 42 Outer ring, 42a End surface, 43 Rolling element, 44 Inner ring raceway, 45 Outer ring raceway, 100, 100A, 100B, 100C, 100D, 100E Motor, 101 Member (Impeller), 102 Magnet, 102a End surface, 102b First part, 102c Second part, 103 Stator core, 104 Coil, 107 Housing, C1 Center position, C2 Center position, FD First direction, L Length, MD Maximum Distance, SD Second direction, S1 Gap, S2 Gap

1. A bearing device comprising:
a shaft including a first end part and a second end part;
a sleeve including a projecting part projecting from an inner peripheral surface opposing an outer peripheral surface of the shaft;
a first bearing including an inner ring, an outer ring, and a rolling element supported between the outer peripheral surface of the shaft and the inner peripheral surface of the sleeve at the first end part side; and
a second bearing including an inner ring, an outer ring, and a rolling element supported between the outer peripheral surface of the shaft and the inner peripheral surface of the sleeve at the second end part side, wherein
the projecting part is disposed between the first bearing and the second bearing in an axial direction of the shaft,
the outer ring of one of the first bearing and the second bearing is in contact with the projecting part, and the outer ring of the other of the first bearing and the second bearing is disposed apart from the projecting part in the axial direction,
the inner ring of the first bearing is disposed at the first end part side relative to the outer ring of the first bearing in the axial direction, and
the inner ring of the second bearing is disposed at the second end part side relative to the outer ring of the second bearing in the axial direction.

2. The bearing device according to claim 1, wherein the inner rings of the first bearing and the second bearing are press-fitted at the outer peripheral surface of the shaft, and the outer rings of the first bearing and the second bearing are clearance-fitted at the inner peripheral surface of the sleeve.

3. The bearing device according to claim 2, wherein the outer ring of one of the first bearing and the second bearing is fixed at the inner peripheral surface of the sleeve with an adhesive.

4. The bearing device according to claim 1, wherein a linear expansion coefficient of the shaft is different from a linear expansion coefficient of the sleeve.

5. A motor comprising:
the bearing device according to claim 1; and
an impeller fixed at the shaft at the first end part side relative to the first bearing.

6. The motor according to claim 5 comprising a rotor fixed at the shaft at the second end part side relative to the second bearing.
